(19) United States
(12) Patent Application Publication
(10) Pub. No.: US 2009/0301669 A1
(43) Pub. Date: Dec. 10, 2009

(54) FOLDABLE NETTED DOOR

(75) Inventor: Manchiu Li, Kowloon (HK)

Correspondence Address: YH CHAN, 42 PIN OAKS DRIVE, PHOENIXVILLE, PA, 19460, US

(73) Assignee: POTTER INDUSTRIES LIMITED, KOWLOON (HK)

(21) Appl. No.: 12/095,501

(22) PCT Filed: Jan. 24, 2006
(86) PCT No.: PCT/CN2006/000125

§ 371 Date: May 29, 2008

(51) Int. Cl. E06B 9/00

(52) U.S. Cl. 160/354

(57) ABSTRACT

A foldable netted door of which the netted door made of soft gauze has one or a plurality of elastic frames disposed in alignment with each other. Corresponding connecting components are disposed a perpendicular edge of the netted door and the corresponding edge of the doorframe on which the netted door is mounted. Therefore, the netted door is detachably connected to the doorframe.

### BACKGROUND OF THE INVENTION

The present invention relates to a household product and more particularly pertains to a foldable netted door.

Presently, screens for preventing mosquito (insect) for doors and windows for household use are generally metal-made mosquito preventing screen doors or mosquito preventing netted windows. These kinds of metal-made mosquito preventing screen doors or mosquito preventing netted windows are formed by using metal (aluminum alloy) to form a frame, and then fixing metal nets (stainless steel) onto the frame. Although these kinds of metal-made mosquito preventing screen doors or mosquito preventing netted windows have strong structure and high durability, they are susceptible to expensive manufacturing costs and inconvenience in installation and disassembly. More particular, as they cannot be reshaped easily, it is difficult to reduce their sizes for storage when they are not in use. Thus, they are relatively inconvenient to use.

### BRIEF SUMMARY OF THE INVENTION

In view of the aforesaid disadvantages now present in the prior art, the object of the present invention is to provide a foldable netted door which is simple in construction, convenient to use, easy for installation and disassembly, convenient for storage and applicable in a wide range of areas.

To attain this, the foldable netted door of the present invention comprises a netted door made of soft gauze, wherein the netted door has one or a plurality of elastic frames disposed in alignment with each other, corresponding connecting components are disposed respectively on a first perpendicular edge of the netted door and a corresponding edge of the doorframe on which the netted door is mounted in order to detachably connect the netted door to the doorframe.

The plurality of elastic frames are disposed in vertical alignment with each other, a left side and a right side of the netted door are each detachably disposed with a supporting rod between two adjacent elastic frames for connecting the two elastic frames.

The plurality of elastic frames are disposed in horizontal alignment with each other, a top side and a bottom side of the netted door are each detachably disposed with a supporting rod between two adjacent elastic frames for connecting the two elastic frames.

The connecting components take the form of nylon fastening strips (VELCRO). A nylon fastening strip is disposed on the first perpendicular edge of the netted door and a corresponding nylon fastening strip is disposed on the corresponding edge of the doorframe, the corresponding nylon fastening strip on the doorframe is detachably connected to the nylon fastening strip on the netted door.

The nylon fastening strip is affixed to the netted door by sewing and the corresponding nylon fastening strip is affixed to the doorframe by adhesives.

The supporting rods are each affixed to the netted door by one or more positioning rings, the positioning rings can be made by soft materials such as cloth.

One or more door handle components are disposed at a substantially middle position of a second perpendicular edge of the netted door which is parallel to the first perpendicular edge disposed with the connecting component; a positioning component is disposed on the doorframe to correspondingly engaged with the door handle component, thereby fixing the netted door relative to the doorframe.

The door handle component takes the form of a pull ring and the positioning component takes the form of a positioning hook.

The door handle component and the positioning component take the form of nylon fastening strips adhered to each other.

The door handle component and the positioning component take the form of magnets attracted to each other.

The construction of the foldable netted door is also applicable to the manufacture of foldable casement for mounting on windows at home.

To use the present invention, decide whether the netted door is to be opened inwardly or outwardly first. If the netted door is to be opened outwardly, the netted door should be installed on the outside of the doorframe; if the netted door is to be opened inwardly, the netted door should be installed on the inside of the doorframe. Then, adhere the nylon fastening strip on a perpendicular edge of the doorframe, and adhere the corresponding nylon fastening strip on the netted door onto the nylon fastening strip already adhered on the doorframe. Thereafter, close the netted door and then install the positioning component on the doorframe at a position corresponding to the door handle component, so that it is convenient for a user to fix the netted door by engaging the door handle component with the positioning component. The netted door can be folded up for storage by the following steps: first, dismount the netted door and remove the supporting rods. Then, fold up the netted door into one-half until each of the elastic frames overlap with each other. Thereafter, hold two parallel opposite sides of the elastic frames and then twist and fold the netted door until it is about one-third of its full size. Finally, tie it up with an elastic band for storage.

### BRIEF DESCRIPTION OF THE DRAWINGS

FIG. 1 shows the construction of the foldable netted door of the present invention.

FIG. 2 is shows the foldable netted door in use.

FIG. 3 is shows the foldable netted door as folded up.

### DETAILED DESCRIPTION OF THE INVENTION

The present invention is further described in detail with the following embodiment and the accompanying drawings.

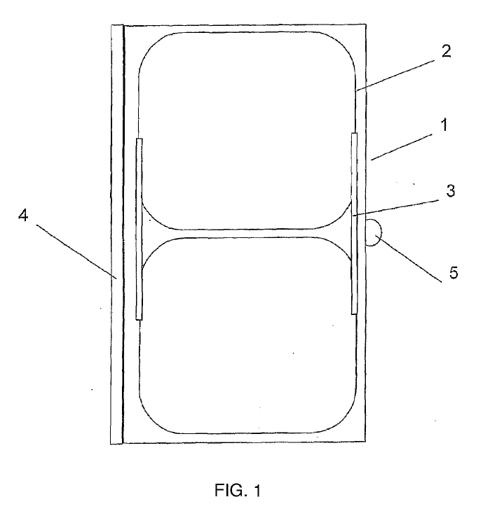

FIG. 1 illustrates the construction of the present invention. As shown in FIG. 1, the present invention comprises a netted door 1 made of soft gauze. The netted door 1 has two elastic frames 2 disposed in vertical alignment with each other. A left side and a right side of the netted door 1 are each detachably disposed with a supporting rod 3 between two adjacent elastic frames 2 for connecting the two elastic frames 2. In other embodiments with simpler constructions, the netted door 1 can has only one elastic frame 2. In other embodiments, the elastic frames 2 may be disposed in horizontal alignment with each other; in this case, a top side and a bottom side of the netted door 1 are each detachably disposed with a supporting rod 3 between two adjacent elastic frames 2 for connecting the two elastic frames 2. In further embodiments, if the size of the netted door 1 is relatively large, there can be three or more elastic frames 2; in this case, if the elastic frames 2 are disposed in vertical alignment with each other, a left side and a right side of the netted door 1 are each disposed with a supporting rod 3 between every two adjacent elastic frames 2; and if the elastic frames 2 are disposed in horizontal alignment with each other, a top side and a bottom side of the netted door 1 are each disposed with a supporting rod 3 between every two adjacent elastic frames 2.

In the present embodiment, the supporting rod 3 is made of plastics. In other embodiments, the supporting rod 3 can be made of metal. A nylon fastening strip 4 is affixed to the first perpendicular edge of the netted door 1 by sewing and a corresponding nylon fastening strip is affixed to the corresponding edge of the doorframe by adhesives (not shown). The corresponding nylon fastening strip on the doorframe is detachably connected to the nylon fastening strip 4 on the netted door 1. A pull ring 5 is disposed at a substantially middle position of a second perpendicular edge of the netted door 1 which is parallel to the first perpendicular edge disposed with the nylon fastening strip 4. The pull ring 5 can be made by soft cloth. A positioning hook (not shown) is disposed on the doorframe to correspondingly engage with the pull ring 5, thereby fixing the netted door 1 relative to the doorframe. In other embodiments, the pull ring 5 and the positioning hook can be replaced by nylon fastening strips adhered to each other or magnets attracted to each other.

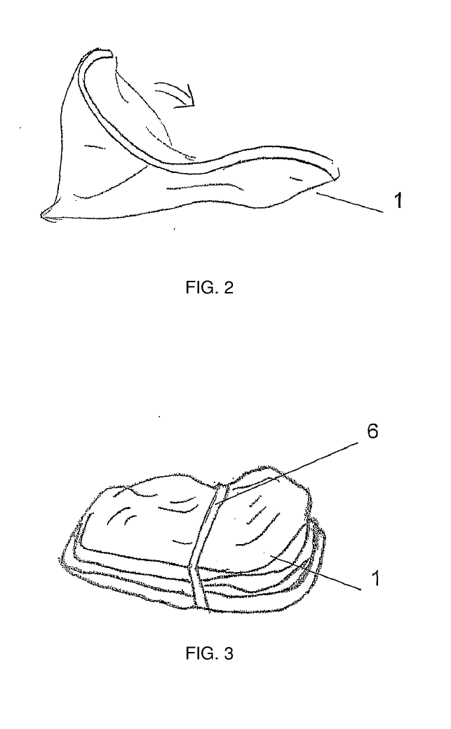

To use the present invention, decide whether the netted door 1 is to be opened inwardly or outwardly first. If the netted door 1 is to be opened outwardly, the netted door 1 should be installed on the outside of the doorframe; if the netted door 1 is to be opened inwardly, the netted door 1 should be installed on the inside of the doorframe. Then, adhere the nylon fastening strip on a perpendicular edge of the doorframe, and adhere the corresponding nylon fastening strip 4 on the netted door 1 onto the nylon fastening strip already adhered on the doorframe. Thereafter, close the netted door 1 and then install the positioning hook on the doorframe at a position corresponding to the pull ring 5, so that it is convenient for a user to fix the netted door 1 by engaging the pull ring 5 with the positioning hook. As shown in FIG. 2, the netted door 1 can be folded up for storage by the following steps: first, dismount the netted door 1 and remove the supporting rods 3. Then, fold up the netted door 1 into one-half until each of the elastic frames 2 overlap with each other. Thereafter, hold two parallel opposite sides of the elastic frames 2 and then twist and fold the netted door 1 until it is about one-third of its full size. Finally, tie it up with an elastic band 6 for storage as shown in FIG. 3.

The above embodiment is a preferred embodiment of the present invention. The present invention is capable of other embodiments and is not limited by the above embodiment. Any other variation, decoration, substitution, combination or simplification, whether in substance or in principle, not deviated from the spirit of the present invention, is replacement or substitution of equivalent effect and falls within the scope of protection of the present invention.

### INDUSTRIAL APPLICABILITY

The present invention has the following advantages and effects in comparison with the prior art: (1) The present invention can be flexibly installed or disassembled according to different requirements. After installation, people can push the netted door directly to pass through the door as if it is an ordinary door. Therefore, it is very convenient. When it is not in use, it can be simply and quickly disassembled and folded up for storage. The supporting rods keep the netted door upright when it is in use, and also render the netted door conveniently folded for storage. (2) The netted door of the present invention is of an assembled structure. All the components are simple and reasonable in construction, easy to manufacture and simple and time-saving for installation. No specific installation tools are required, and installation can be carried out by an ordinary family member. (3) The netted door of the present invention has a lower manufacturing cost in comparison with the metal-made mosquitoes preventing screen doors, and it is easy for processing and convenient for manufacturing. Therefore, it facilitates large-scale applications.

What is claimed is:

1. A foldable netted door which comprises a netted door made of soft gauze, wherein the netted door has one or a plurality of elastic frames disposed in alignment with each other, corresponding connecting components are disposed respectively on a first perpendicular edge of the netted door and a corresponding edge of the doorframe on which the netted door is mounted in order to detachably connect the netted door to the doorframe.

2. The foldable netted door as in claim 1, wherein the plurality of elastic frames are disposed in vertical alignment with each other, a left side and a right side of the netted door are each detachably disposed with a supporting rod between two adjacent elastic frames for connecting the two elastic frames.

3. The foldable netted door as in claim 1, wherein the plurality of elastic frames are disposed in horizontal alignment with each other, a top side and a bottom side of the netted door are each detachably disposed with a supporting rod between two adjacent elastic frames for connecting the two elastic frames.

4. The foldable netted door as in claims 1, 2 or 3, wherein the connecting components take the form of nylon fastening strips (VELCRO); a nylon fastening strip is disposed on the first perpendicular edge of the netted door and a corresponding nylon fastening strip is disposed on the corresponding edge of the doorframe, the corresponding nylon fastening strip on the doorframe is detachably connected to the nylon fastening strip on the netted door.

5. The foldable netted door as in claims 1 or 4, wherein the nylon fastening strip is affixed to the netted door by sewing and the corresponding nylon fastening strip is affixed to the doorframe by adhesives.

6. The foldable netted door as in claims 1, 2 or 3, wherein the supporting rods are each affixed to the netted door by one or more positioning rings.

7. The foldable netted door as in claim 1, wherein one or more door handle components are disposed at a substantially middle position of a second perpendicular edge of the netted door which is parallel to the first perpendicular edge disposed with the connecting component; a positioning component is disposed on the doorframe to correspondingly engaged with the door handle component, thereby fixing the netted door relative to the doorframe.

8. The foldable netted door as in claim 7, wherein the door handle component takes the form of a pull ring and the positioning component takes the form of a positioning hook.

9. The foldable netted door as in claim 7, wherein the door handle component and the positioning component take the form of nylon fastening strips adhered to each other.

10. The foldable netted door as in claim 7, wherein the door handle component and the positioning component take the form of magnets attracted to each other.
